(19) United States
(12) Patent Application Publication
(10) Pub. No.: US 2025/0381529 A1
(43) Pub. Date: Dec. 18, 2025

(54) POLYPHENOL-MODIFIED POLYMERIC MEMBRANE, PREPARATION METHOD THEREFOR AND METALLIZED POLYMERIC MEMBRANE

(71) Applicant: JIANGYIN NANOPORE INNOVATIVE MATERIALS TECHNOLOGY LTD, Jiangsu (CN)

(72) Inventors: Zhongya ZHU, Jiangyin (CN); Jianzhong XIA, Jiangyin (CN); Xuefa LI, Jiangyin (CN); Guoping ZHANG, Jiangyin (CN)

(21) Appl. No.: 18/839,011

(22) PCT Filed: May 25, 2022
(86) PCT No.: PCT/CN2022/094864

§ 371 Date: Feb. 10, 2025

(30) Foreign Application Priority Data
Feb. 17, 2022 (CN) 202210147741.7

(51) Int. Cl. B01D 71/26; B01D 67/00; B01D 71/48; H01M 4/66

(52) U.S. Cl. CPC B01D 71/262; B01D 67/00044; B01D 67/0095; B01D 71/48; H01M 4/666

(57) ABSTRACT

The present disclosure relates to the technical field of film material, and particularly to a polymeric polyphenol-modified polymer film, a preparation method thereof and a metallized polymer film. According to the present disclosure, corona treatment is performed to a surface of a polymer layer, so that a polar modifying liquid can uniformly coat the surface of the polymer layer, thereby forming a modification layer tightly combined with the polymer layer. Thus, the low-polarity polymer layer surface can be imparted with a durable high polarity. Consequently, the polymer layer is capable of being stably and tightly bonded to a material layer with high polarity and high surface tension, such as a metal layer, for a long period of time, effectively broadening the application scenarios for non-polar polymer substrate layers. By controlling the concentrations of the polyphenolic compound and the cross-linking agent in the modifying liquid, the modification layer formed by a cross-linking reaction can have a suitable cross-linking density and an adequate number of hydroxyl groups, thereby further effectively and stably enhancing the long-term polarity and surface tension of the polymer layer. The preparation method is simple and easy to operate, cost-effective, efficient, and easy to scale up.

### TECHNICAL FIELD

The present disclosure relates to the technical field of film material, and particularly to a polymeric polyphenol-modified polymer film, a method for preparing the same, and a metallized polymer film.

### BACKGROUND

Metallized polymer films have attracted much attention from the industry due to their wide applications in the fields of packaging, printing, electronics, etc. In traditional technology, metals are usually directly deposited onto the surfaces of macromolecular polymer films such as polypropylene, polyethylene, and polyester films through physical vapor deposition to prepare metallized polymer films. However, these macromolecular polymer films themselves have relatively weak molecular polarity, and thus have relatively low surface tension. The affinity between the macromolecular polymer films with low surface tension and the metal materials with high surface tension is relatively weak, resulting in low interface adhesion and weak bonding strength between the two types of materials. In order to address this issue, researchers have developed a method of corona treatment to the surfaces of the macromolecular polymer films to increase their surface tension, thereby improving the bonding strength between the macromolecular polymer films and the metal materials.

However, the corona treatment method still has several shortcomings, such as: \textcircled{1} To ensure that the mechanical properties of the macromolecular polymer films are not changed significantly, the surface tension of the macromolecular polymer films after the corona treatment generally ranges from 30 mN/m to 45 mN/m. Compared with the surface tension of the macromolecular polymer films before the corona treatment (20 mN/m to 30 mN/m), the improvement is limited, and there is still a significant gap with the surface tension of metal materials (greater than 100 mN/m), resulting in unsatisfactory bonding effect between the macromolecular polymer films and the metal materials. \textcircled{2}The surface tension of the macromolecular polymer films after corona treatment is unstable. After being stored for a period of time, the surface tension decreases and finally approaches the surface tension before the treatment.

### SUMMARY

Based on the above, there is a need to provide a polymeric polyphenol-modified polymer film and a method for preparing the same. The modified polymer film can maintain high surface tension for a long time without affecting its mechanical properties, so that the film can be stably bonded with a high surface tension metal layer for a long time, forming a high-performance metallized polymer film.

In one aspect of the present disclosure, a method for preparing a polymeric polyphenol-modified polymer film is provided. The method includes the following steps:
providing a polymer layer and performing a corona treatment to a surface of the polymer layer; and
applying a modifying liquid onto the surface of the corona-treated polymer layer and then drying the modifying liquid to obtain a modification layer;
wherein by mass percentage, the modifying liquid includes 0.5% to 4% of a polyphenolic compound and 0.25% to 4% of a cross-linking agent; and
the polyphenolic compound is one or more selected from catechol, pyrogallol, gallic acid, tannic acid, catechin, anthocyanin, quercetin, ellagic acid, eriodictyol, dopamine, chlorogenic acid, luteolin, apigenin, myricetin, and epigallocatechin gallate.

In some embodiments, a material of the polymer layer is one or more selected from polypropylene, polyethylene, polyethylene terephthalate, polybutylene terephthalate, polyethylene naphthalate, polyimide, polypropylene, polyvinyl chloride, polyvinylidene fluoride, polytetrafluoroethylene, polyphenylene sulfide, polyphenylene ether, polystyrene, and copolymers or derivatives thereof.

In some embodiments, the cross-linking agent is a polyamine compound. The polyamine compound is one or more selected from ethylenediamine, 1,2-propylenediamine, 1,3-propylenediamine, hexamethylenediamine, diethylenetriamine, triethylenetetramine, tetraethylenepentamine, polyethyleneimine, piperazine, and m-phenylenediamine.

In some embodiments, in the step of applying the modifying liquid, the modifying liquid is maintained at a temperature in a range from 20° C. to 50° C.

In some embodiments, the modifying liquid is applied by dip coating, and a time period of the dip coating is in a range from 5 minutes to 60 minutes.

In some embodiments, the modifying liquid further includes 0.01% to 0.2% of a surfactant.

In some embodiments, the modifying liquid further includes 0.01% to 0.1% of inorganic nanoparticles.

In some embodiments, the surfactant is one or more selected from sodium dodecyl sulfate, sodium dodecyl sulfonate, sodium dodecylbenzene sulfonate, dodecyltrimethylammonium bromide, Tween 20, Tween 80, polyoxyethylene monolaurate, polyoxyethylene monolaurate, disodium monolauryl sulfosuccinate, potassium monododecyl phosphate, and lauroylamidopropyl betaine.

In some embodiments, a material of the inorganic nanoparticles is one or more selected from silicon dioxide, titanium dioxide, carbon nanotubes, and graphene oxide.

In some embodiments, a particle size of the inorganic nanoparticles is in a range from 2 nm to 20 nm.

In some embodiments, the modifying liquid is dried by heating, a temperature of the heating is in a range from 50° C. to 90° C., and a time period of the heating time is in a range from 1 minute to 5 minutes.

In some embodiments, a thickness of the modification layer is in a range from 20 nm to 500 nm.

In some embodiments, a thickness of the polymer layer is equal to or larger than 2 μm.

In some embodiments, parameters of the corona treatment are power in a range from 10 kW to 30 kW, current in a range from 4 A to 10 A, and treatment line speed in a range from 50 m/min to 200 m/min.

In another aspect of the present disclosure, a polymeric polyphenol-modified polymer film is provided. The polyphenol-modified polymer film is prepared by the method in any one of the embodiments described above.

The present disclosure further provides use of the polymeric polyphenol-modified polymer film in preparation of a medical device, a packaging material, a printed matter, or an electronic component.

In yet another aspect of the present disclosure, a metallized polymer film is provided. The metallized polymer film includes the polymeric polyphenol-modified polymer film, and a metal layer disposed on the modification layer of the polymeric polyphenol-modified polymer film.

The present disclosure further provides a composite current collector including the metallized polymer film.

In some embodiments, the composite current collector further includes a protective layer disposed on a surface of the metallized polymer film. The material of the protective layer is one or more selected from nickel, chromium, nickel-based alloy, copper-based alloy, copper oxide, aluminum oxide, nickel oxide, chromium oxide, cobalt oxide, graphite, carbon black, acetylene black, Ketjen black, carbon nano-quantum dots, carbon nanotubes, carbon nanofibers, and graphene.

In some embodiments, a thickness of the protective layer is in a range from 10 nm to 200 nm.

The present disclosure further provides a battery including the composite current collector in any one of the embodiments described above.

The present disclosure further provides an electronic device including the battery.

By performing the corona treatment to the surface of the polymer layer, the surface of the polymer layer can be uniformly coated with the modifying liquid, which is a polar liquid and forms the modification layer, which is tightly bonded to the polymer layer. Thus, the low-polarity polymer layer surface can be imparted with a durable high polarity, thus possessing relatively high surface tension correspondingly. Consequently, the polymer layer is capable of being stably and tightly bonded to a material layer with high polarity and high surface tension, such as a metal layer, for a long period of time, effectively broadening the application scenarios for non-polar polymer substrate layers. Besides, the formation of the polymeric polyphenols mimics the concept in biomimicry that polyphenolic compounds self-polymerize to construct high-polarity surfaces. Therefore, the formed modified film has good biocompatibility and has potential applications in the fields such as medical devices. By controlling the concentrations of the polyphenolic compound and the cross-linking agent in the modifying liquid, the modification layer formed by a cross-linking reaction can have a suitable cross-linking density and an adequate number of hydroxyl groups, thereby further effectively and stably enhancing the long-term polarity and surface tension of the polymer layer. The preparation method is simple and easy to operate, cost-effective, efficient, and easy to scale up. The surface tension of the modified polymer film can be up to 79 mN/m and does not show a significant decrease even after three months, effectively promoting the firm bonding of the non-polar polymer layer with a polar material layer, such as a metal layer, ensuring stable subsequent processing.

### DETAILED DESCRIPTION

The present disclosure will now be described in detail with reference to the relevant embodiments in order to facilitate understanding of the present disclosure. However, the present disclosure can be implemented in many different forms and is not limited to the embodiments described herein. In contrast, these embodiments are provided only for thorough and comprehensive understanding of the contents of the present disclosure.

In addition, terms “first” and “second” are merely used for describing purposes and cannot be understood as indicating or implying relative importance, or implicitly indicating the number of indicated technical features. In view of that, the features defined with “first” and “second” can explicitly or implicitly include at least one of the features. In the description of the present disclosure, “a plurality of” means at least two, such as two, three, etc., unless otherwise explicitly and specifically defined. In the description of the present disclosure, “several” means at least one, such as one, two, etc., unless otherwise explicitly and specifically defined.

Unless otherwise indicated, all technical and scientific terms used herein have the same meaning as those normally understood by those of ordinary skill in the art. The terms used herein in the specification of the present disclosure are for the purpose of describing specific embodiments only and are not intended to limit the present disclosure. The term “and/or” as used herein includes any and all combinations of one or more relevant listed items.

In the present disclosure, when describing technical features in an open-ended way, the scope encompasses both a closed-ended technical solution consisting of the listed features and an open-ended technical solution including the listed features.

In the present disclosure, unless otherwise specified, when a numerical interval is referred to, the values within this numerical interval are considered continuous and include the minimum value and the maximum value of the range, as well as every value between the minimum and maximum values. Further, when a range refers to integers, the range includes every integer between the minimum and maximum values. Furthermore, when multiple ranges are provided to describe a feature or a characteristic, these ranges can be combined. In other words, ranges disclosed herein are to be construed to include any and all sub-ranges subsumed therein, unless otherwise specified.

Unless otherwise specified, a percentage content involved in the present disclosure refers to mass percentage for both solid-liquid mixing and solid-solid mixing, and refers to volume percentage for liquid-liquid mixing.

Unless otherwise specified, a percentage concentration involved in the present disclosure refers to final concentration, i.e., a proportion of an added component in a system after the addition of the component.

Unless otherwise defined, a temperature parameter in the present disclosure is allowed to refer to not only a constant-temperature treatment, but also a treatment within a certain temperature interval. The constant-temperature treatment allows the temperature to fluctuate within the precision range under the control of an instrument.

In one aspect of the present disclosure, a method for preparing a polymeric polyphenol-modified polymer film is provided. The method includes the following steps:
providing a polymer layer and performing a corona treatment to a surface of the polymer layer; and
applying a modifying liquid onto the surface of the corona-treated polymer layer and then drying the modifying liquid to obtain a modification layer;
wherein by mass percentage, the modifying liquid includes 0.5% to 4% of a polyphenolic compound and 0.25% to 4% of a cross-linking agent; and
the polyphenolic compound is one or more selected from catechol, pyrogallol, gallic acid, tannic acid, catechin, anthocyanin, quercetin, ellagic acid, eriodictyol, dopamine, chlorogenic acid, luteolin, apigenin, myricetin, and epigallocatechin gallate.

By performing the corona treatment to the surface of the polymer layer, the surface of the polymer layer can be uniformly coated with the modifying liquid, which is a polar liquid and forms the modification layer, which is tightly bonded to the polymer layer. Thus, the low-polarity polymer layer surface can be imparted with a durable high polarity, thus possessing relatively high surface tension correspondingly. Consequently, the polymer layer is capable of being stably and tightly bonded to a material layer with high polarity and high surface tension, such as a metal layer, for a long period of time, effectively broadening the application scenarios for non-polar polymer substrate layers. Besides, the formation of the polymeric polyphenols mimics the concept in biomimicry that polyphenolic compounds self-polymerize to construct high-polarity surfaces. Therefore, the formed modification layer has good biocompatibility and has potential applications in the fields such as medical devices. By controlling the concentrations of the polyphenolic compound and the cross-linking agent in the modifying liquid, the modification layer formed by a cross-linking reaction can have a suitable cross-linking density and an adequate number of hydroxyl groups, thereby further effectively and stably enhancing the long-term polarity and surface tension of the polymer layer. The preparation method is simple and easy to operate, cost-effective, efficient, and easy to scale up. The surface tension of the modified polymer film can be up to 79 mN/m and does not show a significant decrease even after three months, effectively promoting the firm bonding of the non-polar polymer layer with a polar material layer, such as a metal layer, and ensuring stable subsequent processing.

Optionally, the polymer layer is prepared by a biaxial stretching process. Further, the polymer layer is prepared by a melt-extrusion biaxial stretching method. As the stretched molecules are oriented, the film prepared by the biaxial stretching process has good physical stability, high mechanical strength, good air tightness, high transparency and high glossiness, and is tough and wear-resistant, thus being widely used in the fields of packaging, printing, electronics, etc.

The polyphenolic compound provides a monomer for polymerization reaction during the formation of the modification layer, enabling the modified polymer layer to have higher polarity and surface tension. In addition, due to the characteristics of the polyphenolic compound, such as oxidation resistance and other potential health-promoting effects, as well as low cytotoxicity, the modified polymer film not only can be bonded with a metal layer, but also can be used in the fields such as medical devices.

Optionally, the mass percentage of the polyphenolic compound in the modifying liquid can be, for example, ranged from 0.5% to 2%, further, for example, can be 0.6%, 0.7%, 0.8%, 0.9%, 1%, 1.1%, 1.2%, 1.3%, 1.4%, 1.5%, 1.6%, 1.7%, 1.8%, 1.9%, 2.5%, 3%, or 3.5%.

Preferably, the polyphenolic compound is one or more selected from catechol, pyrogallol, gallic acid, tannic acid, catechin, and anthocyanin. These polyphenolic compounds can better balance the film-forming performance and the cost.

Optionally, the mass percentage of the cross-linking agent in the modifying liquid can be, for example, ranged from 0.25% to 2%, further, for example, can be 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2.5%, 3%, or 3.5%.

The mass percentages of the polyphenolic compound and the cross-linking agent are controlled within the appropriate ranges, thereby ensuring that the cross-linking reaction can proceed smoothly, preventing uncontrollable reaction and preventing formation of a non-uniform modification layer.

In some embodiments, a material of the polymer layer is one or more selected from polypropylene, polyethylene, polyethylene terephthalate, polybutylene terephthalate, polyethylene naphthalate, polyimide, polypropylene, polyvinyl chloride, polyvinylidene fluoride, polytetrafluoroethylene, polyphenylene sulfide, polyphenylene ether, polystyrene, and copolymers or derivatives thereof.

In some embodiments, the cross-linking agent is a polyamine compound. The polyamine compound is one or more selected from ethylenediamine, 1,2-propylenediamine, 1,3-propylenediamine, hexamethylenediamine, diethylenetriamine, triethylenetetramine, tetraethylenepentamine, polyethyleneimine, piperazine, and m-phenylenediamine.

In some embodiments, in the step of applying the modifying liquid, the modifying liquid is maintained at a temperature in a range from 20° C. to 50° C. Optionally, the temperature of the modifying liquid can be, for example, 25° C., 30° C., 35° C., 40° C., or 45° C. When the modifying liquid is applied, the temperature of the modifying liquid is maintained within the suitable range, which ensures that the cross-linking reaction is more efficient, controllable, and forms a more uniform film.

In some embodiments, the modifying liquid is applied by dip coating, and a time period of the dip coating is in a range from 5 minutes to 60 minutes. Optionally, the time period of the dip coating can be, for example, 10 minutes, 15 minutes, 20 minutes, 25 minutes, 30 minutes, 35 minutes, 40 minutes, 45 minutes, 50 minutes, or 55 minutes. The time period of the dip coating is controlled within the suitable range, which ensures moderate thickness and good uniformity of the film.

In some embodiments, the modifying liquid further includes 0.01% to 0.2% of a surfactant.

In some embodiments, the modifying liquid further includes 0.01% to 0.1% of inorganic nanoparticles. Optionally, the mass percentage of the inorganic nanoparticles can be, for example, 0.01%, 0.02%, 0.03%, 0.04%, 0.05%, 0.06%, 0.07%, 0.08%, 0.09%, 0.1%, 0.11%, 0.12%, 0.13%, 0.14%, 0.15%, 0.16%, 0.17%, 0.18%, or 0.19%. Suitable mass percentage helps to make the inorganic nanoparticles more uniformly dispersed in the modification layer for better functioning.

In some embodiments, the surfactant is one or more selected from sodium dodecyl sulfate, sodium dodecyl sulfonate, sodium dodecylbenzene sulfonate, dodecyltrimethylammonium bromide, Tween 20, Tween 80, polyoxyethylene monolaurate, polyoxyethylene monolaurate, disodium monolauryl sulfosuccinate, potassium monododecyl phosphate, and lauroylamidopropyl betaine.

In some embodiments, a material of the inorganic nanoparticles are one or more selected from silicon dioxide, titanium dioxide, carbon nanotubes, and graphene oxide.

The modification layer contains the inorganic nanoparticles, which can improve the roughness of the modification layer, prevent the adhesion between the film surfaces during a winding process, and improve the bonding strength with a polar layer such as a metal layer. In addition, these inorganic nanoparticles are hydrophilic particles, which can further increase the surface tension of the modification layer.

In some embodiments, a particle size of the inorganic nanoparticles is in a range from 2 nm to 20 nm. Further, the particle size is in a range from 5 nm to 15 nm. Optionally, the particle size of the inorganic nanoparticles can be, for example, 6 nm, 8 nm, 10 nm, 12 nm, or 14 nm. Inorganic nanoparticles with the suitable particle size range can be well dispersed in the modifying liquid and can increase the surface roughness of the modification layer.

In some embodiments, the modifying liquid is dried by heating, a temperature of the heating is in a range from 50° C. to 90° C., and a time period of the heating is in a range from 1 minute to 5 minutes. Optionally, the temperature of the heating can be, for example, 55° C., 60° C., 65° C., 70° C., 75° C., 80° C., or 85° C. The time period of the heating can be, for example, 2 minutes, 3 minutes, or 4 minutes.

In some embodiments, a thickness of the modification layer is in a range from 20 nm to 500 nm. Optionally, the thickness of the modification layer can be, for example, 30 nm to 300 nm, and further can be 35 nm, 40 nm, 45 nm, 50 nm, 55 nm, 60 nm, 65 nm, 70 nm, 75 nm, 80 nm, 85 nm, 90 nm, 105 nm, 110 nm, 115 nm, 120 nm, 125 nm, 130 nm, 135 nm, 140 nm, 145 nm, 150 nm, 155 nm, 160 nm, 165 nm, 170 nm, 175 nm, 180 nm, 185 nm, 190 nm, 195 nm, 200 nm, 225 nm, 250 nm, or 275 nm. The thickness of the modification layer is set within the suitable range, which effectively enhances the polarity and surface tension of the polymer substrate layer while not affecting the thickness or physical properties of the substrate layer.

In some embodiments, a thickness of the polymer layer is equal to or larger than 2 μm. Optionally, the thickness of the polymer layer can be equal to or larger than 4 μm, such as 4.5 μm, 6 μm, 8 μm, 10 μm, 20 μm, etc.

In some embodiments, parameters of the corona treatment are power in a range from 10 kW to 30 kW, current in a range from 4 A to 10 A, and treatment line speed in a range from 50 m/min to 200 m/min. Optionally, the power of the corona treatment can be, for example, 15 kW, 20 kW, or 25 kW. Optionally, the current of the corona treatment can be, for example, 6 A, or 8 A. Optionally, the line speed of the corona treatment can be, for example, 75 m/min, 100 m/min, 125 m/min, 150 m/min, or 175 m/min. The corona treatment can initially increase the surface tension of the polymer layer, so that the aqueous modifying agent can be uniformly spread on the surface of the polymer layer, ensuring that the formed modification layer can be tightly and stably bonded to the polymer layer. The suitable parameters of the corona treatment are more suitable for the composition of the modifying liquid provided in the present disclosure.

In some embodiments, a solvent in the modifying liquid is a polar solvent, for example, one or more selected from water, N,N-dimethylformamide, N,N-dimethylacetamide, and N-methylpyrrolidone.

Preferably, the solvent of the modifying liquid is water, more preferably, deionized water.

In some embodiments, the method for preparing the modifying liquid includes steps of: mixing and stirring raw materials.

In some embodiments, the stirring speed is in a range from 400 rpm to 600 rpm. Preferably, the stirring speed is 500 rpm.

Further, the method for preparing the modifying liquid includes steps of: mixing a polyphenolic compound with a solvent and stirring for 5 minutes to 15 minutes; and adding a cross-linking agent and stirring for another 15 minutes to 25 minutes. Preferably, the polyphenolic compound is mixed with the solvent and stirred for 10 minutes; and then the cross-linking agent is added and stirred for 20 minutes.

Furthermore, the method for preparing the modifying liquid includes steps of: mixing a polyphenolic compound with a solvent and stirring for 5 minutes to 15 minutes; adding a surfactant and stirring until the surfactant is completely dissolved; adding inorganic nanoparticles and ultrasonically dispersing for 0.5 hours to 1.5 hours; and adding a cross-linking agent and stirring for 15 minutes to 25 minutes. Preferably, the polyphenolic compound is mixed with the solvent and stirred for 10 minutes; the surfactant is added and stirred until the surfactant is completely dissolved; inorganic nanoparticles are added and ultrasonically dispersed for 1 hour; and the cross-linking agent is added and stirred for 20 minutes.

In some embodiments, the power of ultrasonic dispersion is in a range from 400 W to 600 W, and the frequency of ultrasonic dispersion is in a range from 35 kHz to 45 kHz. Preferably, the power of ultrasonic dispersion is 500 W, and the frequency of ultrasonic dispersion is 40 KHz.

In some embodiments, after applying the modifying liquid, the surface of the polymer layer is blown with an air knife for 5 seconds to 30 seconds to remove the residual reaction liquid from the surface. Then, the surface of the polymer layer is washed with water for 0.5 minutes to 3 minutes to remove substances that are not firmly bonded with the surface of the polymer layer. After washing, the surface is blown with an air knife for another 5 seconds to 30 seconds, and then dried.

In another aspect of the present disclosure, a polymeric polyphenol-modified polymer film is provided. The polyphenol-modified polymer film is prepared by the preparation method in any one of the embodiments described above. The modified polymer film provided in the present disclosure is a composite of a polymer layer and a modification layer. The polymer layer and the modification layer are tightly combined with each other, so that the non-polar polymer layer surface is provided with an increased polarity which can be maintained for a long time, and is provided with an increased roughness as well, which are conducive to bonding with a polar layer, such as a metal layer, thereby broadening the application scenarios of the polymer layer.

The present disclosure further provides use of the polymeric polyphenol-modified polymer film in preparation of a medical device, a packaging material, a printed matter, or an electronic component.

In yet another aspect of the present disclosure, a metallized polymer film is provided. The metallized polymer film includes the polymeric polyphenol-modified polymer film, and a metal layer disposed on the modification layer of the polymeric polyphenol-modified polymer film. In the metallized polymer film provided by the present disclosure, the polymer layer and the metal layer are tightly bonded via the modification layer, and the bonding strength does not significantly decrease after a long time. The metallized polymer film can be widely used in many fields such as packaging, printing, electronics, etc.

In some embodiments, a material of the metal layer is one or more selected from copper, copper alloy, aluminum, aluminum alloy, nickel, nickel alloy, titanium, and silver.

The present disclosure further provides a composite current collector, including the metallized polymer film.

In some embodiments, when the metallized polymer film is used as a positive electrode composite current collector, the material of the metal layer is preferably aluminum or aluminum alloy, and the aluminum content in the aluminum alloy is greater than or equal to 80 wt. %, andmore preferably is greater than 90 wt. %.

In some embodiments, when the metallized polymer film is used as a negative electrode composite current collector, the material of the metal layer is preferably copper or copper alloy, and the copper content in the copper alloy is greater than or equal to 80 wt. %, and more preferably greater is than 90 wt. %.

In some embodiments, a thickness of the metal layer is in a range from 300 nm to 2000 nm, preferably 500 nm to 1000 nm.

It can be understood that the metal layer can be attached to the surface of the modified polymer film by physical vapor deposition (such as resistance heating vacuum evaporation, electron beam heating vacuum evaporation, laser heating vacuum evaporation, magnetron sputtering, etc.), electroplating, chemical plating, etc.

In some embodiments, the composite current collector further includes a protective layer disposed on the surface of the metallized polymer film to prevent the metal conductive layer from being chemically corroded or mechanically damaged. The material of the protective layer is one or more selected from nickel, chromium, nickel-based alloy, copper-based alloy, copper oxide, aluminum oxide, nickel oxide, chromium oxide, cobalt oxide, graphite, carbon black, acetylene black, Ketjen black, carbon nano quantum dots, carbon nanotubes, carbon nanofibers, and graphene.

In some embodiments, a thickness of the protective layer is in a range from 10 nm to 200 nm. In order to ensure the conductivity of the current collector, the thickness of the protective layer does not exceed one tenth of the thickness of the metal layer.

In some embodiments, the protective layer is prepared by one or more methods selected from physical vapor deposition, in-situ forming, and coating. The vapor deposition is preferably vacuum evaporation and magnetron sputtering. The in-situ forming is a method of preferably in-situ forming a metal oxide passivation layer on the surface of the metal layer. The coating method is preferably die coating, blade coating, or press coating.

The present disclosure further provides a battery, including the composite current collector in any one of the embodiments described above.

The present disclosure further provides an electronic device, including the battery.

The present disclosure is further described in detail below in conjunction with specific examples and comparative examples. For experimental parameters not specified in the following specific examples, reference is made first to the guidance given in the present disclosure, or to the experimental manuals in the art or other experimental methods known in the art, or to the experimental conditions recommended by the manufacturers. It can be understood that specific instruments and raw materials are used in the following examples, but other specific examples may not be limited thereto. The weights of the relevant components mentioned in the examples of the present disclosure represent not only the specific contents of the components, but also the weight proportional relationship between the components. Therefore, as long as the contents of the relevant components are scaled up or down based upon the examples of the present disclosure, they are within the scope disclosed in the examples of the present disclosure. Specifically, the weights described in the examples of the present disclosure can be mass units known in chemistry and chemical industry, such as, μg, mg, g, and kg.

### Example 1

Preparation of dip-coating solution: 100.00 g of tannic acid was added to 9840.00 g of pure water at room temperature and stirred for 10 minutes. Then, 5.00 g of sodium dodecyl sulfate was added to the solution and stirred until completely dissolved. Subsequently, 5.00 g of silicon dioxide was added to the solution and stirred for 20 minutes, followed by ultrasonic dispersion in an ultrasonic cleaner at a power of 500 W and a frequency of 40 kHz at room temperature for 60 minutes. Next, 50.00 g of ethylenediamine was added to the aqueous solution and stirred for 20 minutes. The solute components and concentrations thereof in the prepared aqueous dip-coating solution were: 1.0 wt. % of tannic acid, 0.05 wt. % of sodium dodecyl sulfate, 0.05 wt. % of silicon dioxide, and 0.5 wt. % of ethylenediamine. The chemicals used in the mixing process were all analytically pure. The stirring speed was 500 rpm.

Corona treatment to polypropylene (PP) base film: A PP base film with a thickness of 6 μm was placed in a roll-to-roll corona treatment device, and subjected to corona treatment at a power of 10 KW, a current of 6 A, and a line speed of 50 m/min.

Modification of PP base film by co-deposition: The corona-treated PP base film was immersed in the prepared dip-coating solution at a temperature of 40° C. for 20 minutes. Then, the dip-coated film was blown by an air knife for 5 seconds and washed with deionized water filled in a cleaning tank for 1.5 minutes. Next, the washed film was blown by an air knife for another 5 seconds and then placed in an oven and dried at a temperature of 70° C. for 2 minutes.

Performance test of the modified film:

TABLE 1

| | Initial | | After standing for 3 months | |
|---|---|---|---|---|
| | Surface | Surface | Surface | Surface |
| | tension | roughness | tension | roughness |
| Film | (mN/m) | (nm) | (mN/m) | (nm) |
| PP base film | 30 | 75 | 30 | 76 |
| After corona | 38 | 80 | 32 | 79 |
| treatment | | | | |
| After | 75 | 95 | 74 | 96 |
| modification via | | | | |
| co-deposition | | | | |

### Preparation of Composite Current Collector

Negative electrode composite current collector: First, a metal conductive layer was prepared as follows. The above-obtained co-deposition modified PP film with cleaned surfaces was placed in a vacuum evaporation chamber. A high-purity copper wire with a purity greater than 99.99% was melted and evaporated in a metal evaporation chamber at a high temperature ranged from 1400° C. to 2000° C. The evaporated metal atoms passed through a cooling system in the vacuum evaporation chamber and were deposited on both surfaces of the polymer base film, forming copper metal conductive layers each with a thickness of 1 μm. Next, a protective layer was prepared as follows. 1 g of graphene was uniformly dispersed in 999 g of N-methylpyrrolidone (NMP) solvent by ultrasonic dispersion, to obtain a coating liquid with a solid content of 0.1 wt. %. Then, the coating liquid was evenly coated onto the surfaces of the metal conductive layers by a die coating process, with a coating amount controlled at 80 μm, and finally was dried at 100° C.

Positive electrode composite current collector: First, a metal conductive layer was prepared as follows. The above-obtained co-deposition modified PP film with cleaned surfaces was placed in a vacuum evaporation chamber. A high-purity aluminum wire with a purity greater than 99.99% was melted and evaporated in a metal evaporation chamber at a high temperature ranged from 1300° C. to 2000° C. The evaporated metal atoms passed through a cooling system in the vacuum evaporation chamber and were deposited on both surfaces of the polymer base film, forming aluminum metal conductive layers each with a thickness of 1 μm. Next, a protective layer was prepared as follows. 1 g of carbon nanotubes were uniformly dispersed in 999 g of N-methylpyrrolidone (NMP) solvent by ultrasonic dispersion, to obtain a coating liquid with a solid content of 0.1 wt. %. Then, the coating liquid was evenly coated onto the surfaces of the metal conductive layers by a die coating process, with a coating amount controlled at 90 μm, and finally was dried at 100° C.

Bonding performance test of the composite current collectors: A 3M Scotch tape (model 600 or 610) with a length of 200 mm and a width of 15 mm was attached onto the metal layer on the surface of the composite current collector. The test sample was rolled back and forth twice with a compression roller at a speed of 10 mm/s. Then, the tape was torn off at a speed of 100 mm/min and an angle of 60 degrees. The area proportion of the metal torn off by the tape was statistically analyzed.

Performance test of the composite current collectors:

TABLE 2

| | Area Proportion (%) of metal torn off | |
|---|---|---|
| | by tape in bonding performance test | |
| Support layer of | Positive electrode | Negative electrode |
| composite current collector | current collector | current collector |
| Unmodified PP film | 4.0% | 5.0% |
| Co-deposition modified | 0.19% | 0.18% |
| PP film | | |

### Example 2

Example 2 was basically the same as Example 1, with the following differences.

(1) The base film was a polyethylene terephthalate (PET) film with a thickness of 6 μm. The components of the dip-coating solution were: 1.2 wt. % of catechol, 0.06 wt. % of sodium dodecylbenzene sulfonate, 0.04 wt. % of silicon dioxide, and 0.8 wt. % of tetraethylenepentamine.

(2) Modification of PET base film by co-deposition: The corona-treated PET base film was immersed in the prepared dip-coating solution at a temperature of 45° C. for 15 minutes. Then, the dip-coated film was blown by an air knife for 10 seconds and washed with deionized water filled in a cleaning tank for 2.0 minutes. Next, the washed film was blown by an air knife for another 10 seconds and then placed in an oven and dried at a temperature of 75° C. for 2 minutes.

Performance test of the modified film:

TABLE 3

| | Initial | | After standing for 3 months | |
|---|---|---|---|---|
| | Surface | Surface | Surface | Surface |
| | tension | roughness | tension | roughness |
| Film | (mN/m) | (nm) | (mN/m) | (nm) |
| PET base film | 35 | 80 | 36 | 82 |
| After corona | 42 | 83 | 34 | 80 |
| treatment | | | | |
| After | 73 | 92 | 72 | 94 |
| modification via | | | | |
| co-deposition | | | | |

Performance test of the composite current collectors:

TABLE 4

| | Area Proportion (%) of metal torn off | |
|---|---|---|
| | by tape in bonding performance test | |
| Support layer of | Positive electrode | Negative electrode |
| composite current collector | current collector | current collector |
| Unmodified PET film | 3.0% | 4.0% |
| Co-deposition PET film | 0.21% | 0.20% |

### Example 3

Example 3 was basically the same as Example 1, with the following differences.

The base film was a polypropylene (PP) film with a thickness of 4.5 μm.

The components of the dip-coating solution were: 1.5 wt. % of catechin, 0.08 wt. % of Tween 80, 0.06 wt. % of titanium dioxide, and 1.0 wt. % of triethylenetetramine.

Performance test of the modified film:

TABLE 5

| | Initial | | After standing for 3 months | |
|---|---|---|---|---|
| | Surface | Surface | Surface | Surface |
| | tension | roughness | tension | roughness |
| Film | (mN/m) | (nm) | (mN/m) | (nm) |
| PP base film | 31 | 76 | 30 | 75 |
| After corona | 37 | 79 | 32 | 76 |
| treatment | | | | |
| After | 77 | 92 | 78 | 96 |
| modification via | | | | |
| co-deposition | | | | |

Performance test of the composite current collectors:

TABLE 6

| | Area Proportion (%) of metal area torn | |
|---|---|---|
| | off by tape in bonding performance test | |
| Support layer of | Positive electrode | Positive electrode |
| composite current collector | current collector | current collector |
| Unmodified PP film | 4.1% | 4.5% |
| Co-deposition modified | 0.16% | 0.17% |
| PP film | | |

### Example 4

Example 4 was basically the same as Example 1, with the following differences.

(1) The base film was a polyethylene terephthalate (PET) film with a thickness of 4.5 μm. The components of the dip-coating liquid were: 1.0 wt. % of gallic acid, 0.05 wt. % of sodium dodecyl sulfate, 0.05 wt. % of silicon dioxide, and 0.5 wt. % of polyethyleneimine.

(2) Modification of PET base film by co-deposition: The corona-treated PET base film was immersed in the prepared dip-coating solution at a temperature of 45° C. for 15 minutes. Then, the dip-coated film was blown by an air knife for 10 seconds and washed with deionized water filled in a cleaning tank for 2.0 minutes. Next, the washed film was blown by an air knife for another 10 seconds and then placed in an oven and dried at a temperature of 75° C. for 2 minutes.

Performance test of the modified film:

TABLE 7

| | Initial | | After standing for 3 months | |
|---|---|---|---|---|
| | Surface | Surface | Surface | Surface |
| | tension | roughness | tension | roughness |
| Film | (mN/m) | (nm) | (mN/m) | (nm) |
| PET base film | 36 | 79 | 35 | 81 |
| After corona | 43 | 82 | 37 | 83 |
| treatment | | | | |
| After | 79 | 96 | 80 | 97 |
| modification via | | | | |
| co-deposition | | | | |

Performance test of the composite current collectors:

TABLE 8

| | Area Proportion (%) of metal torn off | |
|---|---|---|
| | by tape in bonding performance test (%) | |
| Support layer of composite | Positive electrode | Negative electrode |
| current collector | current collector | current collector |
| Unmodified PET film | 3.8% | 4.1% |
| Co-deposition PET film | 0.12% | 0.11% |

### Example 5

Example 5 was basically the same as Example 1, with the following differences.

The base film was a polybutylene terephthalate (PBT) film with a thickness of 8 μm.

The components of the dip-coating liquid were: 1.0 wt. % of tannic acid, 0.05 wt. % of sodium dodecyl sulfate, 0.05 wt. % of silicon dioxide, and 0.6 wt. % of tetraethylenepentamine.

Performance test of the modified film:

TABLE 9

| | Initial | | After standing for 3 months | |
|---|---|---|---|---|
| | Surface | Surface | Surface | Surface |
| | tension | roughness | tension | roughness |
| Film | (mN/m) | (nm) | (mN/m) | (nm) |
| PBT base film | 36 | 80 | 35 | 81 |
| After corona | 45 | 84 | 38 | 82 |
| treatment | | | | |
| After | 76 | 96 | 75 | 97 |
| modification via | | | | |
| co-deposition | | | | |

Performance test of the composite current collectors:

TABLE 10

| | Area Proportion (%) of metal torn off | |
|---|---|---|
| | by tape in bonding performance test (%) | |
| Support layer of | Positive electrode | Positive electrode |
| composite current collector | current collector | current collector |
| Unmodified PBT film | 3.9% | 4.7% |
| Co-deposition modified PBT | 0.18% | 0.19% |
| film | | |

### Example 6

Example 6 was basically the same as Example 1, with the following differences.

(1) The base film was a polyethylene naphthalate (PEN) film with a thickness of 8 μm. The components of the dip-coating solution were: 1.2 wt. % of tannic acid, 0.08 wt. % of sodium dodecyl sulfate, 0.05 wt. % of silicon dioxide, and 0.6 wt. % of tetraethylenepentamine.

(2) Modification of PET base film by co-deposition: The corona-treated PET base film was immersed in the prepared dip-coating solution at a temperature of 45° C. for 15 minutes. Then, the dip-coated film was blown by an air knife for 10 seconds and washed with deionized water filled in a cleaning tank for 2.0 minutes. Next, the washed film was blown by an air knife for another 10 seconds and then placed in an oven and dried at a temperature of 75° C. for 2 minutes.

Performance test of the modified film:

TABLE 11

| | | | After standing for | |
|---|---|---|---|---|
| | Initial | | 3 months | |
| | Surface | | Surface | |
| | tension | Surface | tension | Surface |
| Film | (mN/m) | roughness(nm) | (mN/m) | roughness(nm) |
| PBT base film | 34 | 78 | 34 | 80 |
| After corona | 42 | 83 | 36 | 81 |
| treatment | | | | |
| After | 78 | 95 | 76 | 96 |
| modification via | | | | |
| co-deposition | | | | |

Performance test of the composite current collectors:

TABLE 12

| | Area Proportion (%) of metal torn off | |
|---|---|---|
| | by tape in bonding performance test (%) | |
| Support layer of composite | Positive electrode | Negative electrode |
| current collector | current collector | current collector |
| Unmodified PBT film | 4.2% | 4.9% |
| Co-deposition PBT film | 0.14% | 0.17% |

### Comparative Example 1

Comparative Example 1 was basically the same as Example 4, except that in the dip-coating solution the concentration of gallic acid was 8.0 wt % and the concentration of polyethyleneimine was 5.0 wt %.

### Comparative Example 2

Comparative Example 2 was basically the same as Example 4, except that the concentration of polyethyleneimine in the dip-coating solution was 0.2%.

### Comparative Example 3

Comparative Example 3 was basically the same as Example 4, except using a polyester resin instead of gallic acid, and using glutaraldehyde instead of polyethyleneimine.

### Comparative Example 4

Comparative Example 4 was basically the same as Example 4, except using a polyacrylate resin instead of gallic acid, and using glutaraldehyde instead of polyethyleneimine.

### Comparative Example 5

Comparative Example 5 was basically the same as Example 4, except that the temperature of the dip-coating solution was 70° C.

The performance test results of the modified polymer films prepared in Comparative Examples 1 to 5 are shown in Table 13.

TABLE 13

| | | | After standing | |
|---|---|---|---|---|
| | Initial | | for3 months | |
| | Surface | | Surface | |
| | tension | Surface | tension | Surface |
| Film | (mN/m) | roughness(nm) | (mN/m) | roughness(nm) |
| PET base film | 36 ± 1.0 | 79 ± 2.0 | 35 ± 1.0 | 81 ± 1.5 |
| After corona | 43 ± 4.0 | 82 ± 3.0 | 37 ± 1.0 | 83 ± 2.0 |
| treatment | | | | |
| Example 4 | 79 ± 1.2 | 96 ± 2.0 | 80 ± 1.0 | 97 ± 1.5 |
| Comparative | 73 ± 2.5 | 105 ± 5.0 | 70 ± 2.0 | 100 ± 4.0 |
| Example 1 | | | | |
| Comparative | 75 ± 1.8 | 93 ± 2.5 | 69 ± 1.5 | 90 ± 1.8 |
| Example 2 | | | | |
| Comparative | 53 ± 2.0 | 80 ± 2.0 | 52 ± 1.8 | 81 ± 1.8 |
| Example 3 | | | | |
| Comparative | 55 ± 1.7 | 77 ± 1.9 | 53 ± 1.2 | 75 ± 2.0 |
| Example 4 | | | | |
| Comparative | 77 ± 2.4 | 98 ± 3.0 | 74 ± 1.8 | 96 ± 2.0 |
| Example 5 | | | | |

It can be seen from Table 13 that in Comparative Example 1, due to excessively high concentrations of gallic acid and polyethyleneimine, which resulted in nonuniform adhesion of the two components on the surface of the polymer film during the dip coating, the surface tension and roughness of the formed modification layer were nonuniformly distributed. Compared with Example 4, the initial surface tension decreased to some extent and the surface tension after standing for three months decreased significantly, indicating unstable performance. In Comparative Example 2, due to the excessively low concentration of the cross-linking agent, the formed modification layer was not stable enough, and the surface tension was nonuniformly distributed. Although the initial surface tension was not much lower than that of Example 4, the surface tension decreased significantly after long-term standing. In Comparative Examples 3 and 4, gallic acid was replaced with polyester resin and polyacrylate resin respectively for modification, and the corresponding cross-linking agent was changed to glutaraldehyde, which was a common cross-linking agent for resin. The performance of the formed modified film did not change much before and after long-term standing, but was significantly worse than that of Example 4, with both surface tension and roughness being far inferior to those of Example 4. In Comparative Example 5, the temperature of the dip-coating solution was too high, resulting in an overly violent cross-linking reaction and nonuniform film formation, which also greatly affected the performance of the modified film.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims, and the description can be used to explain the content of the claims.

What is claimed is:

1. A method for preparing a polymeric polyphenol-modified polymer film, comprising following steps:
providing a polymer layer and performing a corona treatment to a surface of the polymer layer; and
applying a modifying liquid onto the surface of the corona-treated polymer layer and then drying the modifying liquid to obtain a modification layer;
wherein by mass percentage, the modifying liquid comprises 0.5% to 4% of a polyphenolic compound and 0.25% to 4% of a cross-linking agent; and
the polyphenolic compound is selected from the group consisting of catechol, pyrogallol, gallic acid, tannic acid, catechin, anthocyanin, quercetin, ellagic acid, eriodictyol, dopamine, chlorogenic acid, luteolin, apigenin, myricetin, epigallocatechin gallate, and any combination thereof.

2. The method according to claim 1, wherein a material of the polymer layer is selected from the group consisting of polypropylene, polyethylene, polyethylene terephthalate, polybutylene terephthalate, polyethylene naphthalate, polyimide, polypropylene, polyvinyl chloride, polyvinylidene fluoride, polytetrafluoroethylene, polyphenylene sulfide, polyphenylene ether, polystyrene, copolymers or derivatives thereof, and any combination thereof; and/or
the cross-linking agent is a polyamine compound, and the polyamine compound is selected from the group consisting of ethylenediamine, 1,2-propylenediamine, 1,3-propylenediamine, hexamethylenediamine, diethylenetriamine, triethylenetetramine, tetraethylenepentamine, polyethyleneimine, piperazine, m-phenylenediamine, and any combination thereof.

3. The method according to claim 1, wherein in the step of applying the modifying liquid, the modifying liquid is maintained at a temperature in a range from 20° C. to 50° C.; and/or
the modifying liquid is applied by dip coating, and a time period of the dip coating is in a range from 5 minutes to 60 minutes.

4. The method according to claim 1, wherein the modifying liquid further comprises 0.01% to 0.2% of a surfactant; and/or
the modifying liquid further comprises 0.01% to 0.1% of inorganic nanoparticles.

5. The method according to claim 4, wherein the surfactant is selected from the group consisting of sodium dodecyl sulfate, sodium dodecyl 1 sulfonate, sodium dodecylbenzene sulfonate, dodecyltrimethylammonium bromide, Tween 20, Tween 80, polyoxyethylene monolaurate, polyoxyethylene monolaurate, disodium monolauryl sulfosuccinate, potassium monododecyl phosphate, lauroylamidopropyl betaine, and any combination thereof; and/or
a material of the inorganic nanoparticles is selected from the group consisting of silicon dioxide, titanium dioxide, carbon nanotubes, graphene oxide, and any combination thereof; and/or
a particle size of the inorganic nanoparticles is in a range from 2 nm to 20 nm.

6. The method according to any one of claims 1 to 5, wherein the modifying liquid is dried by heating, a temperature of the heating is in a range from 50° C. to 90° C., and a time period of the heating is in a range from 1 minute to 5 minutes; and/or
a thickness of the modification layer is in a range from 20 nm to 500 nm; and/or
a thickness of the polymer layer is equal to or larger than 2 μm.

7. The method according to any one of claims 1 to 5, wherein parameters of the corona treatment are power in a range from 10 kW to 30 KW, current in a range from 4 A to 10 A, and treatment line speed in a range from 50 m/min to 200 m/min.

8. A polymeric polyphenol-modified polymer film prepared by the method according to any one of claims 1 to 7.

9. Use of the polymeric polyphenol-modified polymer film according to claim 8 in preparation of a medical device, a packaging material, a printed material, or an electronic component.

10. A metallized polymer film comprising the polymeric polyphenol-modified polymer film according to claim 8, and a metal layer disposed on the modification layer of the polymeric polyphenol-modified polymer film.

11. A composite current collector comprising the metallized polymer film according to claim 9.

12. The composite current collector according to claim 11, further comprising a protective layer disposed on a surface of the metallized polymer film;
a material of the protective layer is one or more selected from nickel, chromium, nickel-based alloy, copper-based alloy, copper oxide, aluminum oxide, nickel oxide, chromium oxide, cobalt oxide, graphite, carbon black, acetylene black, Ketjen black, carbon nano-quantum dots, carbon nanotubes, carbon nanofibers, graphene, and any combination thereof; and/or
a thickness of the protective layer is in a range from 10 nm to 200 nm.

13. A battery comprising the composite current collector according to claim 11 or 12.

14. An electronic device comprising the battery according to claim 13.
